(19) United States
(12) Patent Application Publication
(10) Pub. No.: US 2021/0383301 A1
(43) Pub. Date: Dec. 9, 2021

(54) MULTI-SUBJECT FLEXIBLE ENERGY BLOCK BIDDING TRANSACTION SYSTEM AND METHOD IN POWER MARKET

(71) Applicants: North China Electric Power University, Beijing (CN); Beijing Electric Power Trading Center Co., Ltd, Beijing (CN)

(72) Inventors: Dunnan LIU, BEIJING (CN); Bo PANG, BEIJING (CN); Heping JIA, BEIJING (CN); Zhu LI, BEIJING (CN); Li SONG, BEIJING (CN); Mingguang LIU, BEIJING (CN); Guangyu QIN, BEIJING (CN)

(73) Assignees: North China Electric Power University; Beijing Electric Power Trading Center Co., Ltd.

(21) Appl. No.: 17/338,757

(22) Filed: Jun. 4, 2021

(30) Foreign Application Priority Data
Jun. 5, 2020 (CN) 202010502851.1

(51) Int. Cl. G06Q 10/06; G06Q 50/06; H02J 3/00; G06Q 10/04

(52) U.S. Cl. CPC G06Q 10/06315; G06Q 50/06; G06Q 10/04; H02J 3/004; H02J 3/003

(57) ABSTRACT

The invention relates to a multi-subject flexible energy block bidding transaction system and method in a power market. The system includes a login authentication module, a data input module, a first processing module, a second processing module, a third processing module, a data verifying module and an output module, wherein the login authentication module is configured for self-identity confirmation of a power market subject and selecting a power transaction declaration mode; the data input module is configured for inputting an electricity price, an electricity quantity and corresponding time information; the three processing modules carry out matching under different modes, the data verifying module receives matching results obtained by each processing module and carries out safety verification, and the output module outputs final trading results of an electricity quantity and an electricity price of each subject in the power market.

### CROSS REFERENCES TO RELATED APPLICATIONS

The present application claims foreign priority of Chinese Patent Application No. 202010502851.1, filed on Jun. 5, 2020 in the China National Intellectual Property Administration, the disclosures of all of which are hereby incorporated by reference.

### TECHNICAL FIELD

The present invention belongs to the technical field of power information, in particular to a multi-subject flexible energy block bidding transaction system and method in a power market.

### BACKGROUND

With the continuous advancement of power system reform, the number of access subjects in a power market has increased sharply, and types of the market subjects have gradually become diversified, so the transaction demands of the market subjects have become more and more vigorous.

At present, China has gradually established a “medium and long term+spot goods” power market mode and formed a basic trading mechanism. China's medium and long term markets are generally electricity trading markets. Because a power curve is not considered in the trading process, technical characteristics and transaction demands of the market subjects are not reflected. For example, some power generation enterprises, especially wind power and photovoltaic power generation enterprises are limited by resource endowments, and the power generation output thereof shows obvious time periodicity and discontinuity. In a market without considering the power curve, the flexibility and high competitiveness of these enterprises are difficult to play. Meanwhile, as economic benefits of the market subjects have nothing to do with actual power generation and consumption curve shapes, an electricity price becomes the only competitive factor in the market, and the competition and flexibility of the whole market are low. All types of market entities urgently need a power market with high flexibility and high competitiveness to meet interactions between source network and charge storage and the increasingly diversified market transaction demands.

Upon retrieval, it is found that Chinese patent document (CN201710394154) discloses a power transaction implementation method based on a power transaction platform, which proposes a system and method for processing power transaction requests, generating contracts and publishing information to realize intelligent power transactions. However, this document does not realize matching optimization of medium and long term power transactions, and does not consider the demands of flexible resources on the medium and long term transactions. Chinese patent document (201710454950) discloses a monthly self-listed power transaction system and transaction method, which puts forward a method of performing delisted transaction method simply according to a listed electricity quantity and a listed electricity price, distributes the delisted electricity quantity according to a delisted electricity quantity proportion, and designs a corresponding power transaction system. However, this document does not realize the matching optimization of medium and long term power transactions, and does not consider the demands of the flexible resources on the medium and long term transactions.

### SUMMARY

An objective of the present invention is to overcome the shortcomings in the prior art, provide a multi-subject flexible energy block bidding transaction system and method in a power market, and solve a problem that a current medium and long term power market lacks flexibility and competitiveness, which is difficult to meet transaction wishes of market subjects.

The present invention solves the technical problem by adopting the following technical solutions.

A multi-subject flexible energy block bidding transaction system in a power market includes a login authentication module, a data input module, a first processing module, a second processing module, a third processing module, a data verifying module, and an output module;

the login authentication module is configured for self-identity confirmation of a power market subject and selecting a power transaction declaration mode;

the data input module is connected with the login authentication module, and inputs an electricity price, an electricity quantity and corresponding time information according to a market subject type and the declaration mode selected;

the first processing module is connected with the data input module, acquires declaration data of a power consumption enterprise and declaration data of a power generation enterprise which selects an ordinary hour mode, and realizes intelligent matching of energy block transactions in a first stage; the first processing module is also connected with the data verifying module, an intelligent matching result is transmitted to the data verifying module for safety verification, and data passing the safety verification is capable of being transmitted to the output module to issue an instruction; and the first processing module is also connected with the second processing module, and the matching result obtained by the first processing module is transmitted to the second processing module for matching in a second stage;

the second processing module is connected with the data input module and the first processing module, acquires declaration data of a power generation enterprise which selects a flexible hour mode and the transaction matching result obtained by the first processing module, and carries out the intelligent matching in the second stage; the second processing module is also connected with the data verifying module, the intelligent matching result in the second stage is transmitted to the data verifying module for safety verification, and data passing the safety verification is capable of being transmitted to the output module to issue an instruction; and the second processing module is also connected with the third processing module, and the matching result obtained by the second processing module is transmitted to the third processing module for matching in a third stage;

the third processing module is connected with the data input module and the second processing module, acquires declaration data of a power generation enterprise which selects a block mode and the transaction matching result obtained by the second processing module, and carries out the intelligent matching in the third stage; the third processing module is also connected with the data verifying module, the intelligent matching result in the third stage is transmitted to the data verifying module for safety verification, and data passing the safety verification is capable of being transmitted to the output module to issue an instruction;

the data verifying module is connected with the first processing module, the second processing module and the third processing module respectively, receives the matching results obtained by each processing module and performs safety verification, and the data verifying module is also connected with the output module to output data passing the safety verification to form an instruction; and

the output module is connected with the data verifying module, outputs trading results meeting safety verification requirements, obtains final trading results of an electricity quantity and an electricity price of each subject in the power market, and sends out a transaction instruction.

Further, the energy block refers to a power supply amount that the power generation enterprise is capable of providing in a continuous time period.

Further, the power market subject includes two big categories that include the power generation enterprise and the power consumption enterprise;

the power transaction declaration mode includes the ordinary hour mode, the flexible hour mode and the block mode;

in the ordinary hour mode, the market subject needs to declare a transaction demand at all times of a day, and trading of the electricity quantity in each hour is independent of each other;

in the flexible hour mode, the market subject only declares a transaction demand of one hour, and the declared electricity quantity of the market subject under the mode is only traded within an acceptable clearing time period specified by the market subject; and

in the block mode, the market subject declares a transaction demand of a continuous time period, and electricity quantities in the continuous time period are traded or not traded at the same time.

Further, data input by the data input module are respectively:

the declaration data of the power generation enterprise in the ordinary hour mode including: declared electricity quantities and declared electricity prices for 24 continuous hours throughout the day;

the declaration data of the power generation enterprise in the flexible hour mode including: an electricity quantity of one hour needing to be transacted, an electricity price and an acceptable trading time period;

the declaration data of the power generation enterprise in the block mode including: an electricity quantity of a certain continuous time period, an electricity price and an acceptable trading time period; and

declaration data of a power consumer including: declared electricity quantities and declared electricity prices for 24 continuous hours throughout the day.

A transaction method of the multi-subject flexible energy block bidding transaction system in the power market according to claim 1, includes the following steps of:

Step 1. selecting, by the power transaction market subject, a declaration mode through the login authentication module;

Step 2. collecting, by the data input module, declaration data of each market subject;

Step 3. determining, by the first processing module, a preliminary trading result of the power transaction in the ordinary hour mode;

Step 4. performing, by the data verifying module, safety verification on the preliminary trading result in the ordinary hour mode;

Step 5. calculating, by the first processing module, all-day social welfare under the trading result at the current case as a judgment basis for optimizing a power transaction result;

Step 6. matching, by the second processing module, electricity sales demands adopting the flexible hour declaration mode according to the power transaction result under the ordinary hour mode; and performing, by the data verifying module, safety verification on the preliminary trading result in the flexible hour mode;

Step 7. matching, by the third processing module, electricity sales demands adopting the block mode according to the power transaction result under the flexible hour mode; and performing, by the data verifying module, safety verification on the preliminary trading result in the block mode; and

Step 8. forming, by the output module, trading results corresponding to the ordinary hour mode, the flexible hour mode and the block mode.

Further, the specific processing method in the Step 3 includes the following steps of:

(1) screening out declaration data of power generation enterprises which select the ordinary mode, and merging declared electricity quantities of the same electricity price information of the power generation enterprises in each time period to obtain electricity sales demand information of the power generation enterprises in each time period; and merging declared electricity quantities of the same electricity price information of power consumers in each time period to obtain electricity purchase information of the power consumers in each time period;

(2) in a certain time period, soring the declared electricity prices of the power generation enterprises from lower to higher to form a supply curve; and similarly, sorting the declared electricity prices of the power consumers from higher to lower to form a demand curve, and calculating a difference ΔP between the declared electricity prices of the power consumers and the declared electricity prices of the power generation enterprises every two in turn to obtain a series of price difference combinations; and

(3) according to a high-low matching method, determining a preliminary trading result of the power transaction.

Further, the specific processing method in the Step (3) includes the following steps of:

\textcircled{1} making a transaction according to that ΔP is from big to small, and failing to make a transaction when ΔP<0; and

\textcircled{2} when ΔP are equal, processing according to three situations:

i. if the price difference between one power generation enterprise and a plurality of power consumers is the same, when the declared electricity quantity of the power generation enterprise is greater than or equal to a sum of the declared electricity quantities of the power consumers, making the transaction according to the declared electricity quantities of the power consumers; when the declared electricity quantity of the power generation enterprise is less than the sum of the declared electricity quantities of the power consumers, distributing, by the power consumers, the declared electricity quantity of the power generation enterprise according to a proportion of the declared electricity quantities;

ii. if the price difference between one power consumer and a plurality of power generation enterprises is the same, when the declared electricity quantity of the power consumer is greater than or equal to a sum of the declared electricity quantities of the power generation enterprises, making the transaction according to the declared electricity quantities of the power generation enterprises; and when the declared electricity quantity of the power consumer is less than the sum of the declared electricity quantities of the power generation enterprises, distributing, by the power generation enterprises, the declared electricity quantities to the power consumer according to a proportion of the declared electricity quantities; and

iii. if the price difference between a plurality of power consumers and a plurality of power generation enterprises is the same, when a sum of the declared electricity quantities of the power generation enterprises is greater than or equal to a sum of the declared electricity quantities of the power consumers, distributing, by the power generation enterprises, the declared electricity quantities to the power consumers according to a proportion of the declared electricity quantities; and when a sum of the declared electricity quantities of the power sales subjects is less than the sum of the declared electricity quantities of the power consumers, distributing, by the power consumers, the declared electricity quantities of the power generation enterprises according to a proportion of the declared electricity quantities;

\textcircled{3} under a certain group of tradable price differences, if the declared electricity quantities of the power generation enterprises and the declared electricity quantities of the power consumers are different, generating a remaining electricity quantity to be traded, wherein the remaining electricity quantity is capable of continuing to participate in the electricity quantity matching of other price difference groups; and

\textcircled{4} by analogy, obtaining a preliminary trading result corresponding to 24 hours a day.

Further, a calculation formula C of the social welfare in the Step 5 is as follows:

$$C = {\sum }_{j = 1}^{24} ( {\sum }_{i = 1}^{n} {q}_{bij}^{′} {p}_{bij} - {\sum }_{i = 1}^{m} {q}_{sij}^{′} {p}_{sij} )$$

wherein, q′ₛᵢⱼ and pₛᵢⱼ respectively represent a traded electricity quantity and a declared electricity price of an i^{th} power generation enterprise at a j^{th} time period respectively, while q′_{bij} and p_{bij} respectively represent a traded electricity quantity and a declared electricity price of an ith power consumer at the ja time period.

Further, the specific implementation method of the Step 6 includes the following steps of:

(1) receiving a supply curve, a demand curve and a social welfare value corresponding to the ordinary hour mode as an initial supply curve, an initial demand curve and an initial social welfare value;

(2) according to a declaration time sequence, adding the supplied electricity quantity of the flexible hour mode to the initial supply curve according to a price order to form a new initial supply curve, and form new trading results one by one according to the trading matching method;

(3) calculating the all-day social welfare under the trading result, wherein if the social welfare increases, the declared electricity quantity is traded; if the social welfare decreases or remains unchanged, the declared electricity quantity is incapable of being traded; if the transaction is successful, updating the initial supply curve and the social welfare; and if the transaction is not traded, remaining the initial supply curve and the social welfare value unchanged;

(4) repeating the process until all the transaction demands that select the flexible hour declaration mode are all subjected to the matching procedure; and

(5) performing, by the data verifying module, safety verification on the preliminary trading results in the flexible hour mode, and obtaining a power transaction result in the flexible hour mode.

Further, the specific implementation method of the Step 7 includes the following steps of:

(1) receiving a supply curve, a demand curve and a social welfare value corresponding to the flexible hour mode as an initial supply curve, an initial demand curve and an initial social welfare value;

(2) according to a declaration time sequence, adding the supplied electricity quantity of each hour selecting the block mode to a supplied electricity quantity sequence of a corresponding time period to form a new supply curve of the corresponding time period, and form new trading results one by one according to the above trading matching method;

(3) calculating the all-day social welfare under the trading result, wherein if the social welfare increases, the declared electricity quantities of the several time periods are traded at the same time; if the social welfare decreases or remains unchanged, the declared electricity quantities are incapable of being traded; if the transaction is successful, updating the initial supply curve and the social welfare; and if the transaction is not traded, remaining the initial supply curve unchanged;

(4) repeating the process until all the transaction demands that select the block declaration mode are all subjected to the matching procedure; and

(5) performing, by the data verifying module, safety verification on the preliminary trading results in the block mode, and finally obtaining a power transaction result in the block mode.

The advantages and effective results of the present invention are as follows:

According to the categories of the energy blocks, the present invention classifies the power transaction declaration modes into the ordinary hour mode, the flexible hour mode and the block mode, allows the power generation enterprises to participate in medium and long term power transactions in the form of energy blocks. The power generation enterprises select appropriate declaration modes to declare power generation output curves according to transaction demands and technical characteristics, and the power consumers (including power sales companies the power consumption enterprises, etc.) directly declare power demand curves. After all curves are decomposed by hours by the transaction institutions, the power generation and consumption curves are repeatedly matched step by step according to the principle of maximizing social welfare, so as to form the final transaction result, which realizes the efficient matching of the declared electricity quantities of various flexible subjects, meets the transaction demand of diversified market subjects, makes the transaction result fully reflect transaction willingness of the market subjects, makes the power transaction process more independent and fair, and fully stimulates the market vitality.

### BRIEF DESCRIPTION OF THE DRAWINGS

FIG. 1 is a connection diagram of a multi-subject flexible energy block bidding transaction system in a power market according to the present invention;

FIG. 2 is a flowchart of a multi-subject flexible energy block bidding transaction method in a power market according to the present invention;

FIG. 3 is a flowchart of matching of a second processing module according to the present invention;

FIG. 4 is a flowchart of matching of a third processing module according to the present invention; and

FIG. 5 is a schematic diagram of power supply and demand curves (taking data of a first hour of an embodiment as an example).

### DETAILED DESCRIPTION

The present invention will be further described hereinafter in detail with reference to the drawings.

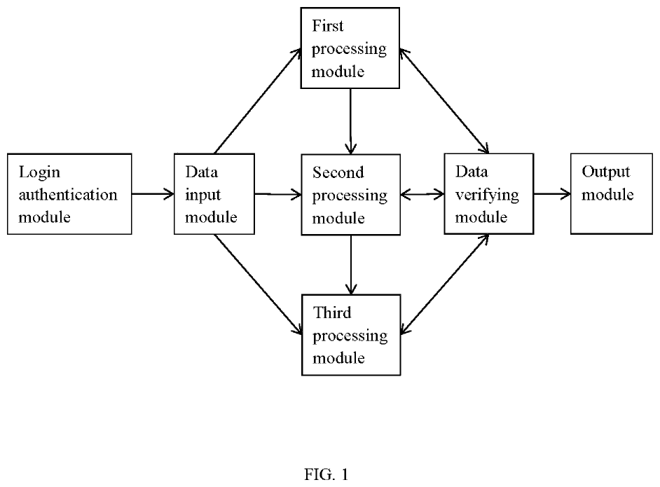

A multi-subject flexible energy block bidding transaction system in a power market, as shown in FIG. 1, includes a login authentication module, a data input module, a first processing module, a second processing module, a third processing module, a data verifying module, and an output module. Wherein:

1. the login authentication module is mainly configured for self-identity confirmation of a power market subject and selecting a power transaction declaration mode.

In a power transaction system, the power market subject includes two big categories that include a power generation enterprise and a power consumption enterprise. In the stage of login authentication, the market subject can select different power transaction declaration modes according to categories of energy blocks.

The energy block refers to a power supply amount that the power generation enterprise can provide in a continuous time period. This continuous time period is established according to a basic time unit of a specific market transaction. For example, in a market with 15 minutes as the minimum transaction time period, the energy block is namely a power supply amount combined in several continuous 15-minute transaction time periods. To adapt to current power transaction rules, the energy block time period proposed by the present invention is in hours, but the related methods are not limited and the time period may be extended to a shorter time.

The power transaction declaration mode includes the ordinary hour mode, the flexible hour mode and the block mode.

In the ordinary hour mode, the market subject needs to declare a transaction demand at all times of a day, and trading of the electricity quantity in each hour is independent of each other.

In the flexible hour mode, the market subject only declares a transaction demand of one hour, and the declared electricity quantity of the market subject under the mode is only traded within an acceptable clearing time period specified by the market subject (the same subject can declare several times in this mode, and clearing orders are sorted according to declaration time).

In the block mode, the market subject declares a transaction demand of a continuous time period, for example, three hours (greater than or equal to two hours). In this case, the electricity quantities in the continuous time period are traded or not traded at the same time (the same subject can declare several times in this mode, and clearing orders are sorted according to declaration time).

The power generation enterprises may select the appropriate declaration mode according to their own technical characteristics and transaction needs, wherein: the market subjects without special requirements select the ordinary hour declaration mode; the market subjects with limited power generation capacity but no special requirements on the transaction time periods select the flexible hour declaration mode; and the market subjects with time continuity requirements or specific transaction strategies for power generation may select the block declaration mode.

Power consumers can only select the ordinary hour declaration mode. In the future, with the continuous opening and improvement of the power market transactions, the power consumers can also select other modes, and a related intelligent matching algorithm is consistent with the present invention, and will not be elaborated.

2. The data input module is connected with the login authentication module, and inputs an electricity price, an electricity quantity and corresponding time information according to a market subject type and the declaration mode selected. The data input module may be further connected to the existing power transaction system, so as to automatically collect data reported by each market subject at a terminal of the power transaction system.

With respect to different power market subjects and declaration modes, the data input by the data input module are respectively as follows:

the declaration data of the power generation enterprise in the ordinary hour mode including: declared electricity quantities and declared electricity prices for 24 continuous hours throughout the day;

the declaration data of the power generation enterprise in the flexible hour mode including: an electricity quantity of one hour needing to be transacted, an electricity price and an acceptable trading time period;

the declaration data of the power generation enterprise in the block mode including: an electricity quantity of a certain continuous time period, an electricity price and an acceptable trading time period.

The market transaction declaration data may be expressed as a collection of the electricity quantity and the electricity price, so transaction requests of the power generation enterprises may be expressed as:

{(qₛᵢ₁,pₛᵢ₁),(qₛᵢ₂,pₛᵢ₂), . . . ,(qₛᵢⱼ,pₛᵢⱼ)}

Transaction requests of the power consumers may be expressed as:

{(q_{bi1},p_{bi1}),(q_{bi2},p_{bi2}), . . . ,(q_{bij},p_{bij})}

wherein, qₛᵢⱼ and pₛᵢⱼ respectively represent a declared electricity quantity and a declared electricity price of an i^{th} power generation enterprise at a j^{th} time period respectively, while q_{bij} and p_{bij} respectively represent a declared electricity quantity and a declared electricity price of an i^{th} power consumer at the j^{th} time period.

3. The first processing module is connected with the data input module, acquires declaration data of a power consumption enterprise and declaration data of a power generation enterprise which selects an ordinary hour mode, and realizes intelligent matching of energy block transactions in a first stage. The first processing module is connected with the data verifying module, an intelligent matching result is transmitted to the data verifying module for safety verification, and data passing the safety verification is capable of being transmitted to the output module to issue an instruction. The first processing module is also connected with the second processing module, and the matching result obtained by the first processing module may also be transmitted to the second processing module for matching in a second stage.

4. The second processing module is connected with the data input module and the first processing module, acquires declaration data of a power generation enterprise which selects a flexible hour mode and the transaction matching result obtained by the first processing module, and carries out the intelligent matching in the second stage. The second processing module is connected with the data verifying module, the intelligent matching result in the second stage is transmitted to the data verifying module for safety verification, and data passing the safety verification is capable of being transmitted to the output module to issue an instruction. The second processing module is also connected with the third processing module, and the matching result obtained by the second processing module may further be transmitted to the third processing module for matching in a third stage.

5. The third processing module is connected with the data input module and the second processing module, acquires declaration data of a power generation enterprise which selects a block mode and the transaction matching result obtained by the second processing module, and carries out the intelligent matching in the third stage. The third processing module is also connected with the data verifying module, the intelligent matching result in the third stage is transmitted to the data verifying module for safety verification, and data passing the safety verification is capable of being transmitted to the output module to issue an instruction.

6. The data verifying module is connected with the first processing module, the second processing module and the third processing module respectively, receives the matching results obtained by each processing module and carries out safety verification. The data verifying module is connected with the output module, and can output the data passing the safety verification to form an instruction.

7. The output module is connected with the data verifying module, outputs trading results meeting safety verification requirements, obtains final trading results of an electricity quantity and an electricity price of each subject in the power market, and sends out a transaction instruction.

It should be noted that the second processing module and the third processing module do not necessarily act. When the data input module does not have the declaration data of the power generation enterprises corresponding to the flexible hour mode or the block mode, a transaction matching action may not occur, and the transaction result of the previous stage may be directly transmitted to next stage or directly transmitted to the output module.

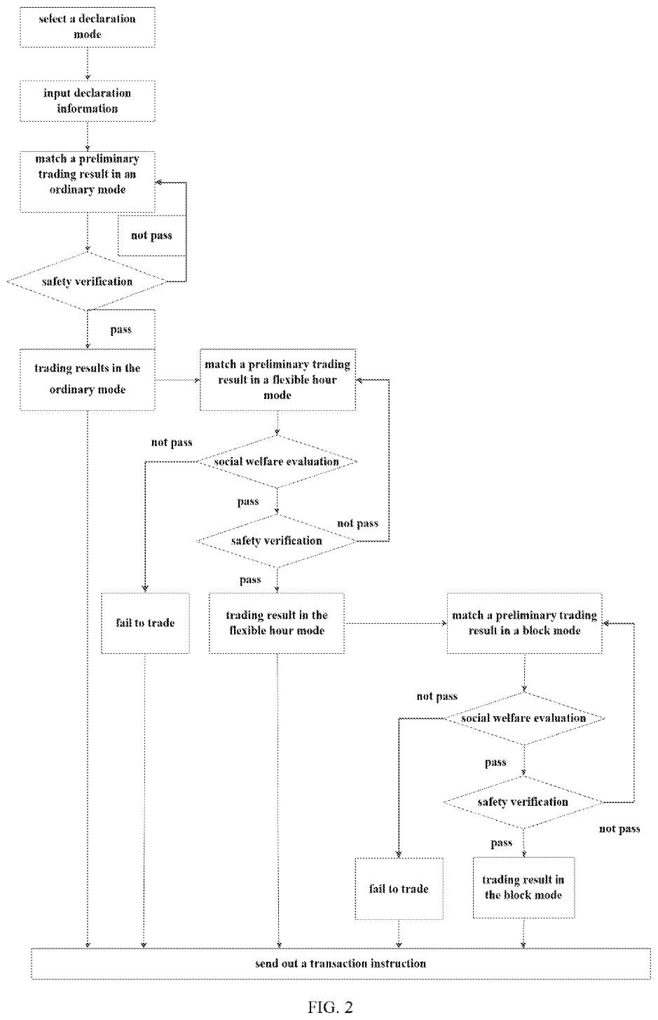

Based on the multi-subject flexible energy block bidding transaction system in the power market above, the present invention further provides a multi-subject flexible energy block bidding transaction method in a power market, as shown in FIG. 2, including the following steps of:

Step 1. selecting, by a power transaction market subject, a declaration mode through a login authentication module.

In this step, the power generation enterprises may select the appropriate declaration modes according to their own technical characteristics and transaction needs, wherein: the subjects without special requirements select the ordinary hour declaration mode; the subjects with limited power generation capacity but no special requirements on the transaction time periods select the flexible hour declaration mode; and the subjects with time continuity requirements or specific transaction strategies for power generation may select the block declaration mode.

The power consumers can only select the ordinary hour declaration mode.

Step 2. collecting, by a data input module, declaration data of each market subject, including data of electricity quantity and electricity price with timestamps.

In this step, the data input module collects the data declared by the power market subject, wherein the declaration data of the power consumers includes: declared electricity quantities and declared electricity prices for 24 continuous hours throughout the day; the declaration data of the power generation enterprise in the ordinary hour mode including declared electricity quantities and declared electricity prices for 24 continuous hours throughout the day, the declaration data of the power generation enterprise in the flexible hour mode including an electricity quantity of one hour needing to be transacted, an electricity price and an acceptable trading time period; and the declaration data of the power generation enterprise in the block mode including an electricity quantity of a certain continuous time period, an electricity price and an acceptable trading time period.

Step 3. determining, by the first processing module, a preliminary trading result of the power transaction in the ordinary hour mode.

The step processing method of this step is as follows:

(1) screening out declaration data of power generation enterprises which select the ordinary mode, and merging declared electricity quantities of the same electricity price information of the power generation enterprises in each time period to obtain electricity sales demand information of the power generation enterprises in each time period; and merging declared electricity quantities of the same electricity price information of power consumers in each time period to obtain electricity purchase information of the power consumers in each time period;

(2) in a certain time period, soring the declared electricity prices of the power generation enterprises from lower to higher to form a supply curve; similarly, sorting the declared electricity prices of the power consumers from higher to lower to form a demand curve, and calculating a difference ΔP between the declared electricity prices of the power consumers and the declared electricity prices of the power generation enterprises every two in turn to obtain a series of price difference combinations; and

(3) according to the mature high-low matching method at present, determining a preliminary trading result of the power transaction.

The high-low matching method of this step is as follows:

\textcircled{1} making a transaction according to that ΔP is from big to small, and failing to make a transaction when ΔP<0; and

\textcircled{2} when ΔP are equal, processing according to three situations:

i. if the price difference between one power generation enterprise and a plurality of power consumers (one to more) is the same, when the declared electricity quantity of the power generation enterprise is greater than or equal to a sum of the declared electricity quantities of the power consumers, making the transaction according to the declared electricity quantities of the power consumers; when the declared electricity quantity of the power generation enterprise is less than the sum of the declared electricity quantities of the power consumers, distributing, by the power consumers, the declared electricity quantity of the power generation enterprise according to a proportion of the declared electricity quantities;

ii. if the price difference between one power consumer and a plurality of power generation enterprises (more to one) is the same, when the declared electricity quantity of the power consumer is greater than or equal to a sum of the declared electricity quantities of the power generation enterprises, making the transaction according to the declared electricity quantities of the power generation enterprises; and when the declared electricity quantity of the power consumer is less than the sum of the declared electricity quantities of the power generation enterprises, distributing, by the power generation enterprises, the declared electricity quantities to the power consumer according to a proportion of the declared electricity quantities; and

iii. if the price difference between a plurality of power consumers and a plurality of power generation enterprises (more to more) is the same, when a sum of the declared electricity quantities of the power generation enterprises is greater than or equal to a sum of the declared electricity quantities of the power consumers, distributing, by the power generation enterprises, the declared electricity quantities to the power consumers according to a proportion of the declared electricity quantities; and when a sum of the declared electricity quantities of the power sales subjects is less than the sum of the declared electricity quantities of the power consumers, distributing, by the power consumers, the declared electricity quantities of the power generation enterprises according to a proportion of the declared electricity quantities;

\textcircled{3} under a certain group of tradable price differences, if the declared electricity quantities of the power generation enterprises and the declared electricity quantities of the power consumers are different, generating a remaining electricity quantity to be traded, wherein the remaining electricity quantity is capable of continuing to participate in the electricity quantity matching of other price difference groups; and the matching method is the same as above; and

\textcircled{4} by analogy, obtaining a preliminary trading result corresponding to 24 hours a day. The preliminary trading result is output to the data verifying module for safety verification to finally obtain a power transaction result in the ordinary hour mode.

Step 4. performing, by the data verifying module, safety verification on the preliminary trading result in the ordinary hour mode.

According to power flow control requirements of the power grid, a power dispatching organization performs safety verification on the preliminary trading result, and finally obtains the power transaction result in the ordinary hour mode.

Step 5. calculating, by the first processing module, all-day social welfare under the trading result at the current case as a judgment basis for optimizing a power transaction result. A calculation formula of the social security is as follows:

$$C = {\sum }_{j = 1}^{24} ( {\sum }_{i = 1}^{n} {q}_{bij}^{′} {p}_{bij} - {\sum }_{i = 1}^{m} {q}_{sij}^{′} {p}_{sij} )$$

wherein, q′ₛᵢⱼ and pₛᵢⱼ respectively represent a traded electricity quantity and a declared electricity price of an i^{th} power generation enterprise at a j^{th} time period respectively, while and p respectively represent a traded electricity quantity and a declared electricity price of an i^{th} power consumer at the j^{th} time period.

Step 6. matching, by the second processing module, electricity sales demands adopting the flexible hour declaration mode according to the power transaction result under the ordinary hour mode; and performing, by the data verifying module, safety verification on the preliminary trading result in the flexible hour mode.

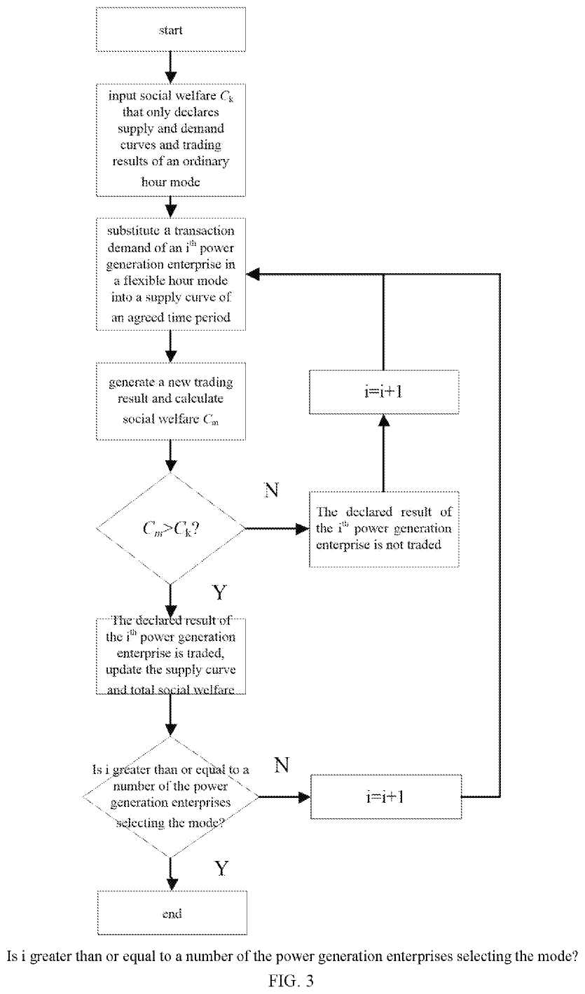

As shown in FIG. 3, the specific implementations method of this step is as follows:

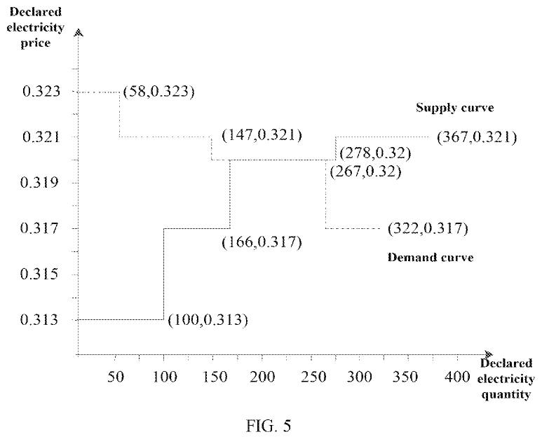

(1) receiving a supply curve, a demand curve and a social welfare value corresponding to the ordinary hour mode, as shown in FIG. 5, as an initial supply curve, an initial demand curve and an initial social welfare value;

(2) according to a declaration time sequence, adding the supplied electricity quantity of the flexible hour mode to the initial supply curve according to a price order to form a new initial supply curve, and form new trading results one by one according to the trading matching method;

(3) calculating the all-day social welfare under the trading result, wherein if the social welfare increases, the declared electricity quantity is traded; if the social welfare decreases or remains unchanged, the declared electricity quantity is incapable of being traded; if the transaction is successful, updating the initial supply curve and the social welfare (which is the new supply curve formed in the previous process); and if the transaction is not traded, remaining the initial supply curve and the social welfare value unchanged;

(4) repeating the process until all the transaction demands that select the flexible hour declaration mode are all subjected to the matching procedure; and

(5) performing safety verification on the preliminary trading result in the flexible hour mode. According to the power flow control requirements of the power grid, the power dispatching organization performs safety verification on the preliminary trading result, and finally obtains the power transaction result in the flexible hour mode.

Step 7. matching, by the third processing module, electricity sales demands adopting the block mode according to the power transaction result under the flexible hour mode; and performing, by the data verifying module, safety verification on the preliminary trading result in the block mode.

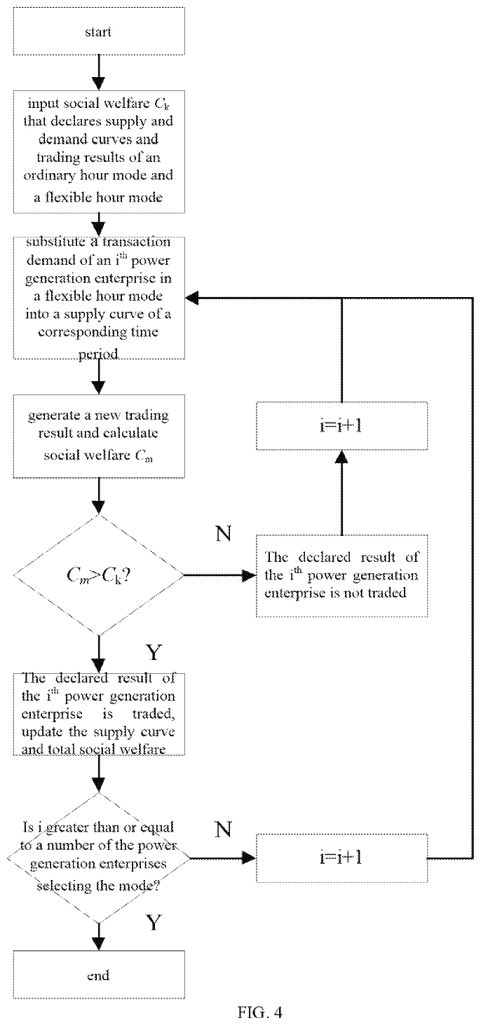

As shown in FIG. 4, the specific processing method of this step is as follows:

(1) receiving a supply curve, a demand curve and a social welfare value corresponding to the flexible hour mode as an initial supply curve, an initial demand curve and an initial social welfare value;

(2) according to a declaration time sequence, adding the supplied electricity quantity of each hour selecting the block mode to a supplied electricity quantity sequence of a corresponding time period to form a new supply curve of the corresponding time period, and form new trading results one by one according to the above trading matching method;

(3) calculating the all-day social welfare under the trading result, wherein if the social welfare increases, the declared electricity quantities of the several time periods are traded at the same time; if the social welfare decreases or remains unchanged, the declared electricity quantities are incapable of being traded; if the transaction is successful, updating the initial supply curve (which is the new supply curve formed in the previous process) and the social welfare; and if the transaction is not traded, remaining the initial supply curve unchanged;

(4) repeating the process until all the transaction demands that select the block declaration mode are all subjected to the matching procedure; and

(5) performing, by the data verifying module, safety verification on the preliminary trading result in the block mode. According to the power flow control requirements of the power grid, the power dispatching organization performs safety verification on the preliminary trading result, and finally obtains the power transaction result in the block mode. Step 8. forming, by the output module, trading results corresponding to the ordinary hour mode, the flexible hour mode and the block mode.

Taking power declaration data of a certain day of a provincial power market as an example, the flexible transaction results of the energy blocks are calculated. The market subjects include 6 power generation enterprises and 5 power consumers, wherein the power generation enterprises 1 to 4 participate in the basic mode declaration, and the power generation enterprise 5 participates in the flexible hour mode declaration. The acceptable trading time period are three time periods including 4 to 5, 12 to 14 and 18 to 20, and the declared electricity quantity in each time period is 91. The power generation enterprise 6 participates in the block mode declaration, and the declaration time periods thereof are the two time periods including 4 to 6 and 16 to 19. The declaration data of each market subject is as follows:

TABLE 1
Declaration data of power generation enterprises

| | Power | | Power | | Power | | Power | | Power | | Power | |
|---|---|---|---|---|---|---|---|---|---|---|---|---|
| | generation | | generation | | generation | | generation | | generation | | generation | |
| | enterprise 1 | | enterprise 2 | | enterprise 3 | | enterprise 4 | | enterprise 5 | | enterprise 6 | |
| Time | Electricity | Electricity | Electricity | Electricity | Electricity | Electricity | Electricity | Electricity | Electricity | Electricity | Electricity | Electricity |
| period | quantity | price | quantity | price | quantity | price | quantity | price | quantity | price | quantity | price |
| 1 | 100 | 0.313 | 112 | 0.32 | 66 | 0.317 | 89 | 0.321 | | | | |
| 2 | 102 | 0.313 | 99 | 0.32 | 67 | 0.317 | 83 | 0.321 | | | | |
| 3 | 89 | 0.313 | 96 | 0.32 | 56 | 0.317 | 76 | 0.321 | | | | |
| 4 | 98 | 0.313 | 97 | 0.32 | 61 | 0.317 | 79 | 0.321 | 91 | 0.32 | 88 | 0.318 |
| 5 | 99 | 0.313 | 99 | 0.32 | 55 | 0.317 | 77 | 0.321 | | | 88 | 0.318 |
| 6 | 100 | 0.313 | 91 | 0.32 | 58 | 0.317 | 74 | 0.321 | | | 88 | 0.318 |
| 7 | 89 | 0.313 | 94 | 0.32 | 66 | 0.317 | 80 | 0.321 | | | | |
| 8 | 93 | 0.313 | 99 | 0.32 | 67 | 0.317 | 83 | 0.321 | | | | |
| 9 | 99 | 0.313 | 98 | 0.32 | 56 | 0.317 | 77 | 0.321 | | | | |
| 10 | 80 | 0.313 | 95 | 0.32 | 61 | 0.317 | 78 | 0.321 | | | | |
| 11 | 85 | 0.313 | 97 | 0.32 | 55 | 0.317 | 76 | 0.321 | | | | |
| 12 | 88 | 0.313 | 100 | 0.32 | 58 | 0.317 | 79 | 0.321 | 91 | 0.319 | | |
| 13 | 102 | 0.313 | 102 | 0.32 | 66 | 0.317 | 84 | 0.321 | | | | |
| 14 | 112 | 0.313 | 89 | 0.32 | 67 | 0.317 | 78 | 0.321 | | | | |
| 15 | 99 | 0.313 | 98 | 0.32 | 56 | 0.317 | 77 | 0.321 | | | | |
| 16 | 96 | 0.313 | 99 | 0.32 | 61 | 0.317 | 80 | 0.321 | | | 88 | 0.32 |
| 17 | 97 | 0.313 | 100 | 0.32 | 55 | 0.317 | 77 | 0.321 | | | 88 | 0.32 |
| 18 | 99 | 0.313 | 89 | 0.32 | 58 | 0.317 | 73 | 0.321 | 91 | 0.319 | 88 | 0.32 |
| 19 | 91 | 0.313 | 93 | 0.32 | 66 | 0.317 | 79 | 0.321 | | | 88 | 0.32 |
| 20 | 94 | 0.313 | 99 | 0.32 | 67 | 0.317 | 83 | 0.321 | | | | |
| 21 | 99 | 0.313 | 80 | 0.32 | 56 | 0.317 | 68 | 0.321 | | | | |
| 22 | 98 | 0.313 | 85 | 0.32 | 61 | 0.317 | 73 | 0.321 | | | | |
| 23 | 95 | 0.313 | 88 | 0.32 | 55 | 0.317 | 71 | 0.321 | | | | |
| 24 | 97 | 0.313 | 102 | 0.32 | 58 | 0.317 | 80 | 0.321 | | | | |

TABLE 2
Declaration data of power consumers

| | Power consumer 1 | | Power consumer 2 | | Power consumer 3 | | Power consumer 4 | | Power consumer 5 | |
|---|---|---|---|---|---|---|---|---|---|---|
| Time | Electricity | Eectricity | Electricity | Electricity | Electricity | Electricity | Electricity | Electricity | Electricity | Electricity |
| period | quantity | price | quantity | price | quantity | price | quantity | price | quantity | price |
| 1 | 66 | 0.32 | 58 | 0.323 | 55 | 0.317 | 89 | 0.321 | 54 | 0.32 |
| 2 | 67 | 0.32 | 66 | 0.323 | 58 | 0.317 | 95 | 0.321 | 57 | 0.32 |
| 3 | 56 | 0.32 | 67 | 0.323 | 66 | 0.317 | 94 | 0.321 | 57 | 0.32 |
| 4 | 61 | 0.32 | 56 | 0.323 | 67 | 0.317 | 92 | 0.321 | 55 | 0.32 |
| 5 | 55 | 0.32 | 61 | 0.323 | 55 | 0.317 | 85 | 0.321 | 51 | 0.32 |
| 6 | 58 | 0.32 | 55 | 0.323 | 58 | 0.317 | 85 | 0.321 | 51 | 0.32 |
| 7 | 66 | 0.32 | 58 | 0.323 | 66 | 0.317 | 95 | 0.321 | 57 | 0.32 |
| 8 | 67 | 0.32 | 66 | 0.323 | 67 | 0.317 | 100 | 0.321 | 60 | 0.32 |
| 9 | 56 | 0.32 | 67 | 0.323 | 56 | 0.317 | 89 | 0.321 | 54 | 0.32 |
| 10 | 61 | 0.32 | 56 | 0.323 | 61 | 0.317 | 89 | 0.321 | 53 | 0.32 |
| 11 | 55 | 0.32 | 61 | 0.323 | 56 | 0.317 | 86 | 0.321 | 52 | 0.32 |
| 12 | 58 | 0.32 | 55 | 0.323 | 61 | 0.317 | 87 | 0.321 | 52 | 0.32 |
| 13 | 66 | 0.32 | 58 | 0.323 | 55 | 0.317 | 89 | 0.321 | 54 | 0.32 |
| 14 | 67 | 0.32 | 61 | 0.323 | 58 | 0.317 | 93 | 0.321 | 56 | 0.32 |
| 15 | 56 | 0.32 | 55 | 0.323 | 58 | 0.317 | 84 | 0.321 | 51 | 0.32 |
| 16 | 61 | 0.32 | 58 | 0.323 | 66 | 0.317 | 92 | 0.321 | 55 | 0.32 |
| 17 | 55 | 0.32 | 66 | 0.323 | 67 | 0.317 | 94 | 0.321 | 56 | 0.32 |
| 18 | 58 | 0.32 | 67 | 0.323 | 56 | 0.317 | 90 | 0.321 | 54 | 0.32 |
| 19 | 66 | 0.32 | 56 | 0.323 | 66 | 0.317 | 94 | 0.321 | 56 | 0.32 |
| 20 | 67 | 0.32 | 61 | 0.323 | 67 | 0.317 | 97 | 0.321 | 58 | 0.32 |
| 21 | 56 | 0.32 | 55 | 0.323 | 56 | 0.317 | 83 | 0.321 | 50 | 0.32 |
| 22 | 61 | 0.32 | 58 | 0.323 | 61 | 0.317 | 90 | 0.321 | 54 | 0.32 |
| 23 | 55 | 0.32 | 55 | 0.323 | 55 | 0.317 | 82 | 0.321 | 50 | 0.32 |
| 24 | 58 | 0.32 | 60 | 0.323 | 58 | 0.317 | 88 | 0.321 | 53 | 0.32 |

The trading results and the social welfare calculation results under the basic mode are as follows:

| | Traded power quantity of power | | | | Traded power quantity of power | |
|---|---|---|---|---|---|---|
| Time | generation enterprise | | | | consumer | |
| period | Enterprise 1 | Enterprise 2 | Enterprise 3 | Enterprise 4 | Consumer 1 | Consumer 2 |
| 1 | 100 | 101 | 66 | 0 | 66 | 58 |
| 2 | 102 | 99 | 67 | 0 | 57.8 | 66 |
| 3 | 89 | 96 | 56 | 0 | 39.6 | 67 |
| 4 | 98 | 97 | 61 | 0 | 56.8 | 56 |
| 5 | 99 | 98 | 55 | 0 | 55 | 61 |
| 6 | 100 | 91 | 58 | 0 | 58 | 55 |
| 7 | 89 | 94 | 66 | 0 | 51.5 | 58 |
| 8 | 93 | 99 | 67 | 0 | 49.1 | 66 |
| 9 | 99 | 98 | 56 | 0 | 56 | 67 |
| 10 | 80 | 95 | 61 | 0 | 48.7 | 56 |
| 11 | 85 | 97 | 55 | 0 | 46.3 | 61 |
| 12 | 88 | 100 | 58 | 0 | 54.8 | 55 |
| 13 | 102 | 98 | 66 | 0 | 66 | 58 |
| 14 | 112 | 89 | 67 | 0 | 62.1 | 61 |
| 15 | 99 | 91 | 56 | 0 | 56 | 55 |
| 16 | 96 | 99 | 61 | 0 | 55.7 | 58 |
| 17 | 97 | 100 | 55 | 0 | 45.6 | 66 |
| 18 | 99 | 89 | 58 | 0 | 46.1 | 67 |
| 19 | 91 | 93 | 66 | 0 | 54.1 | 56 |
| 20 | 94 | 99 | 67 | 0 | 54.7 | 61 |
| 21 | 99 | 80 | 56 | 0 | 51.2 | 55 |
| 22 | 98 | 85 | 61 | 0 | 50.9 | 58 |
| 23 | 95 | 88 | 55 | 0 | 52.9 | 55 |
| 24 | 97 | 102 | 58 | 0 | 57.0 | 60 |
| | | | | Social welfare | | |
| | Traded power quantity of power | | | of power | Social welfare | Total |
| Time | consumer | | | generation | of power | social |
| period | Consumer 3 | Consumer 4 | consumer 5 | enterprise | consumer | welfare |
| 1 | 0 | 89 | 54 | 84.542 | 85.703 | 1.161 |
| 2 | 0 | 95 | 49.2 | 84.845 | 86.053 | 1.208 |
| 3 | 0 | 94 | 40.4 | 76.329 | 77.415 | 1.086 |
| 4 | 0 | 92 | 51.2 | 81.051 | 82.18 | 1.129 |
| 5 | 0 | 85 | 51 | 79.782 | 80.908 | 1.126 |
| 6 | 0 | 85 | 51 | 78.806 | 79.93 | 1.124 |
| 7 | 0 | 95 | 44.5 | 78.859 | 79.949 | 1.09 |
| 8 | 0 | 100 | 43.9 | 82.028 | 83.178 | 1.15 |
| 9 | 0 | 89 | 54 | 80.099 | 81.25 | 1.151 |
| 10 | 0 | 89 | 42.3 | 74.777 | 75.777 | 1 |
| 11 | 0 | 86 | 43.7 | 75.08 | 76.109 | 1.029 |
| 12 | 0 | 87 | 49.2 | 77.93 | 78.972 | 1.042 |
| 13 | 0 | 89 | 54 | 84.521 | 85.703 | 1.182 |
| 14 | 0 | 93 | 51.9 | 84.775 | 86.036 | 1.261 |
| 15 | 0 | 84 | 51 | 77.859 | 78.969 | 1.11 |
| 16 | 0 | 92 | 50.3 | 81.065 | 82.186 | 1.121 |
| 17 | 0 | 94 | 46.4 | 79.796 | 80.932 | 1.136 |
| 18 | 0 | 90 | 42.9 | 77.853 | 79.011 | 1.158 |
| 19 | 0 | 94 | 45.9 | 79.165 | 80.262 | 1.097 |
| 20 | 0 | 97 | 47.3 | 82.341 | 83.48 | 1.139 |
| 21 | 0 | 83 | 45.8 | 74.339 | 75.448 | 1.109 |
| 22 | 0 | 90 | 45.1 | 77.211 | 78.344 | 1.133 |
| 23 | 0 | 82 | 48.1 | 75.33 | 76.407 | 1.077 |
| 24 | 0 | 88 | 52.0 | 81.387 | 82.508 | 1.121 |

| | | | |
|---|---|---|---|
| Total | 1909.77 | 1936.71 | 26.940 |

Considering the supplied electricity quantity in the flexible hour mode, the power generation enterprise 5 increases the power supply in the three time periods of 4 to 5, 12 to 14 and 18 to 20, resulting in the trading results and the social welfare calculation results as follows:

| | Power generation enterprise 5 | | | | | | |
|---|---|---|---|---|---|---|---|
| | | | Preliminarily | | | | Actually |
| | Declared | Declared | traded | | Reference | | traded |
| Time | electricity | electricity | electricity | Total social | value for | | electricity |
| period | quantity | price | quantity | welfare | judgment | Traded or not | quantity |
| 4 | 91 | 0.32 | 50.8 | 26.940 | 26.940 | Not traded | 0 |
| 5 | | | 46.9 | 26.940 | 26.940 | Not traded | 0 |
| 12 | 91 | 0.319 | 91 | 27.031 | 26.940 | Traded | 91 |
| 13 | | | 0 | | | | |
| 14 | | | 0 | | | | |
| 18 | 91 | 0.319 | 91 | 27.122 | 27.031 | Traded | 91 |
| 19 | | | | | | | |
| 20 | | | | | | | |

In this case, the power generation enterprise 5 gets the preliminarily traded electricity quantity in the acceptable time periods of 4 to 5, but the total all-day social welfare remains unchanged, so it is impossible to actually make a transaction. In the acceptable time periods of 12 to 14, alter the supplied electricity quantity is traded in the 12th hour, the total all-day social welfare is increased to 27.031, so the transaction can be made. In the acceptable time periods of 18 to 20, alter the supplied electricity quantity is traded in the 18th hour, the total all-day social welfare is increased to 27.122, so the transaction can be made.

Considering the supplied electricity quantity in the block mode, the power generation enterprise 6 increases the power supply in the two time periods of 4 to 6, and 16 to 19, resulting in the trading results and the social welfare calculation results as follows:

| | Power generation enterprise 6 | | | | | | |
|---|---|---|---|---|---|---|---|
| | | | Preliminarily | | | | Actually |
| | Declared | Declared | traded | | Reference | | traded |
| Time | electricity | electricity | electricity | Total social | value for | | electricity |
| period | quantity | price | quantity | welfare | judgment | Traded or not | quantity |
| 4 | 88 | 0.318 | 88 | 27.650 | 27.122 | Traded | 88 |
| 5 | 88 | 0.318 | 88 | | | | 88 |
| 6 | 88 | 0.318 | 88 | | | | 88 |
| 16 | 88 | 0.32 | 51.3 | 27.650 | 27.650 | Not traded | 0 |
| 17 | 88 | 0.32 | 55.7 | | | | 0 |
| 18 | 88 | 0.32 | 10.4 | | | | 0 |
| 19 | 88 | 0.32 | 55.9 | | | | 0 |

The supplied electricity quantity of the power generation enterprise 6 is traded in the time periods of 4 to 6, and the total all-day social welfare is increased to 27.650. In the time periods of 16 to 19, the total all-day social welfare brought by the supplied electricity quantity is unchanged, and the transaction cannot be made.

Considering the basic mode, the flexible hour mode and the block mode, the all-day trading situations of the market subjects are shown in the following table:

| Time | Traded power quantity of power generation enterprise | | | | | |
|---|---|---|---|---|---|---|
| period | Enterprise 1 | Enterprise 2 | Enterprise 3 | Enterprise 4 | Enterprise 5 | Enterprise 6 |
| 1 | 100 | 101 | 66 | 0 | | |
| 2 | 102 | 99 | 67 | 0 | | |
| 3 | 89 | 96 | 56 | 0 | | |
| 4 | 98 | 17 | 61 | 0 | | 88 |
| 5 | 99 | 10 | 55 | 0 | | 88 |
| 6 | 100 | 3 | 58 | 0 | | 88 |
| 7 | 89 | 94 | 66 | 0 | | |
| 8 | 93 | 99 | 67 | 0 | | |
| 9 | 99 | 98 | 56 | 0 | | |
| 10 | 80 | 95 | 61 | 0 | | |
| 11 | 85 | 97 | 55 | 0 | | |
| 12 | 88 | 15 | 58 | 0 | 91 | |
| 13 | 103 | 98 | 66 | 0 | | |
| 14 | 112 | 89 | 67 | 0 | | |
| 15 | 99 | 91 | 56 | 0 | | |
| 16 | 96 | 99 | 61 | 0 | | |
| 17 | 97 | 100 | 55 | 0 | | |
| 18 | 99 | 21 | 58 | 0 | 91 | |
| 19 | 91 | 93 | 66 | 0 | | |
| 20 | 94 | 99 | 67 | 0 | | |
| 21 | 99 | 80 | 56 | 0 | | |
| 22 | 98 | 85 | 61 | 0 | | |
| 23 | 95 | 88 | 55 | 0 | | |
| 24 | 97 | 102 | 58 | 0 | | |
| | Time | Traded power quantity of power consumer | | | | |
| | period | Consumer 1 | Consumer 2 | Cconsumer 3 | Consumer 4 | Consumer 5 |
| | 1 | 66 | 58 | 0 | 89 | 54 |
| | 2 | 57.8 | 66 | 0 | 95 | 49.2 |
| | 3 | 39.6 | 67 | 0 | 94 | 40.4 |
| | 4 | 61 | 56 | 0 | 92 | 55 |
| | 5 | 55 | 61 | 0 | 85 | 51 |
| | 6 | 58 | 55 | 0 | 85 | 51 |
| | 7 | 51.5 | 58 | 0 | 95 | 44.5 |
| | 8 | 49.1 | 66 | 0 | 100 | 43.9 |
| | 9 | 49.4 | 67 | 0 | 89 | 47.6 |
| | 10 | 48.7 | 56 | 0 | 89 | 42.3 |
| | 11 | 46.3 | 61 | 0 | 86 | 43.7 |
| | 12 | 58 | 55 | 0 | 87 | 52 |
| | 13 | 66 | 58 | 0 | 89 | 54 |
| | 14 | 62.1 | 61 | 0 | 93 | 51.9 |
| | 15 | 56 | 55 | 0 | 84 | 51 |
| | 16 | 55.7 | 58 | 0 | 92 | 50.3 |
| | 17 | 45.6 | 66 | 0 | 94 | 46.4 |
| | 18 | 58 | 67 | 0 | 90 | 54 |
| | 19 | 54.1 | 56 | 0 | 94 | 45.9 |
| | 20 | 54.7 | 61 | 0 | 97 | 47.3 |
| | 21 | 51.2 | 55 | 0 | 83 | 45.8 |
| | 22 | 50.9 | 58 | 0 | 90 | 45.1 |
| | 23 | 52.9 | 55 | 0 | 82 | 48.1 |
| | 24 | 57.0 | 60 | 0 | 88 | 52.0 |

Through the above processing process, the efficient matching of the declared electricity quantities of various flexible subjects can be realized, and the transaction demand of diversified market subjects can be met.

It should be emphasized that the embodiments described in the present invention are illustrative, not restrictive, so the present invention includes but is not limited to the embodiments described in the detailed description, and other embodiments obtained by those skilled in the art according to the technical solutions of the present invention also belong to the scope of protection of the present invention.

What is claimed is:

1. A multi-subject flexible energy block bidding transaction system in a power market, comprising: a login authentication module, a data input module, a first processing module, a second processing module, a third processing module, a data verifying module and an output module, wherein:
the login authentication module is configured for self-identity confirmation of a power market subject and selecting a power transaction declaration mode;
the data input module is connected with the login authentication module, and inputs an electricity price, an electricity quantity and corresponding time information according to a market subject type and the declaration mode selected;
the first processing module is connected with the data input module, acquires declaration data of a power consumption enterprise and declaration data of a power generation enterprise which selects an ordinary hour mode, and realizes intelligent matching of energy block transactions in a first stage; the first processing module is also connected with the data verifying module, an intelligent matching result is transmitted to the data verifying module for safety verification, and data passing the safety verification is capable of being transmitted to the output module to issue an instruction; and the first processing module is also connected with the second processing module, and the matching result obtained by the first processing module is transmitted to the second processing module for matching in a second stage;
the second processing module is connected with the data input module and the first processing module, acquires declaration data of a power generation enterprise which selects a flexible hour mode and the transaction matching result obtained by the first processing module, and carries out the intelligent matching in the second stage; the second processing module is also connected with the data verifying module, the intelligent matching result in the second stage is transmitted to the data verifying module for safety verification, and data passing the safety verification is capable of being transmitted to the output module to issue an instruction; and the second processing module is also connected with the third processing module, and the matching result obtained by the second processing module is transmitted to the third processing module for matching in a third stage;
the third processing module is connected with the data input module and the second processing module, acquires declaration data of a power generation enterprise which selects a block mode and the transaction matching result obtained by the second processing module, and carries out the intelligent matching in the third stage; the third processing module is also connected with the data verifying module, the intelligent matching result in the third stage is transmitted to the data verifying module for safety verification, and data passing the safety verification is capable of being transmitted to the output module to issue an instruction;
the data verifying module is connected with the first processing module, the second processing module and the third processing module respectively, receives the matching results obtained by each processing module and carries out safety verification, and the data verifying module is also connected with the output module to output data passing the safety verification to form an instruction; and
the output module is connected with the data verifying module, outputs trading results meeting safety verification requirements, obtains final trading results of an electricity quantity and an electricity price of each subject in the power market, and sends out a transaction instruction.

2. The multi-subject flexible energy block bidding transaction system in the power market according to claim 1, wherein the energy block refers to a power supply amount that the power generation enterprise is capable of providing in a continuous time period.

3. The multi-subject flexible energy block bidding transaction system in the power market according to claim 1, wherein the power market subject comprises two big categories that comprise the power generation enterprise and the power consumption enterprise;
the power transaction declaration mode comprises the ordinary hour mode, the flexible hour mode and the block mode;
in the ordinary hour mode, the market subject needs to declare a transaction demand at all times of a day, and trading of the electricity quantity in each hour is independent of each other,
in the flexible hour mode, the market subject only declares a transaction demand of one hour, and the declared electricity quantity of the market subject under the mode is only traded within an acceptable clearing time period specified by the market subject; and
in the block mode, the market subject declares a transaction demand of a continuous time period, and electricity quantities in the continuous time period are traded or not traded at the same time.

4. The multi-subject flexible energy block bidding transaction system in the power market according to claim 1, wherein data input by the data input module are respectively:
the declaration data of the power generation enterprise in the ordinary hour mode comprising: declared electricity quantities and declared electricity prices for 24 continuous hours throughout the day;
the declaration data of the power generation enterprise in the flexible hour mode comprising: an electricity quantity of one hour needing to be transacted, an electricity price and an acceptable trading time period;
the declaration data of the power generation enterprise in the block mode comprising: an electricity quantity of a certain continuous time period, an electricity price and an acceptable trading time period; and
declaration data of a power consumer comprising: declared electricity quantities and declared electricity prices for 24 continuous hours throughout the day.

5. A transaction method of the multi-subject flexible energy block bidding transaction system in the power market according to claim 1, comprising the following steps of:
Step 1. selecting, by the power transaction market subject, a declaration mode through the login authentication module;
Step 2. collecting, by the data input module, declaration data of each market subject;
Step 3. determining, by the first processing module, a preliminary trading result of the power transaction in the ordinary hour mode;
Step 4. performing, by the data verifying module, safety verification on the preliminary trading result in the ordinary hour mode;
Step 5. calculating, by the first processing module, all-day social welfare under the trading result at the current case as a judgment basis for optimizing a power transaction result;
Step 6. matching, by the second processing module, electricity sales demands adopting the flexible hour declaration mode according to the power transaction result under the ordinary hour mode; and performing, by the data verifying module, safety verification on the preliminary trading result in the flexible hour mode;
Step 7. matching, by the third processing module, electricity sales demands adopting the block mode according to the power transaction result under the flexible hour mode; and performing, by the data verifying module, safety verification on the preliminary trading result in the block mode; and
Step 8. forming, by the output module, trading results corresponding to the ordinary hour mode, the flexible hour mode and the block mode.

6. The transaction method of the multi-subject flexible energy block bidding transaction system in the power market according to claim 5, wherein the specific processing method in the Step 3 comprises the following steps of:
(1) screening out declaration data of power generation enterprises which select the ordinary mode, and merging declared electricity quantities of the same electricity price information of the power generation enterprises in each time period to obtain electricity sales demand information of the power generation enterprises in each time period; and merging declared electricity quantities of the same electricity price information of power consumers in each time period to obtain electricity purchase information of the power consumers in each time period;
(2) in a certain time period, soring the declared electricity prices of the power generation enterprises from lower to higher to form a supply curve; and similarly, sorting the declared electricity prices of the power consumers from higher to lower to form a demand curve, and calculating a difference ΔP between the declared electricity prices of the power consumers and the declared electricity prices of the power generation enterprises every two in turn to obtain a series of price difference combinations; and
(3) according to a high-low matching method, determining a preliminary trading result of the power transaction.

7. The transaction method of the multi-subject flexible energy block bidding transaction system in the power market according to claim 6, wherein the specific processing method in the Step (3) comprises the following steps of:
\textcircled{1} making a transaction according to that ΔP is from big to small, and failing to make a transaction when ΔP<0; and
\textcircled{2} when ΔP are equal, processing according to three situations:
i. if the price difference between one power generation enterprise and a plurality of power consumers is the same, when the declared electricity quantity of the power generation enterprise is greater than or equal to a sum of the declared electricity quantities of the power consumers, making the transaction according to the declared electricity quantities of the power consumers; when the declared electricity quantity of the power generation enterprise is less than the sum of the declared electricity quantities of the power consumers, distributing, by the power consumers, the declared electricity quantity of the power generation enterprise according to a proportion of the declared electricity quantities;
ii. if the price difference between one power consumer and a plurality of power generation enterprises is the same, when the declared electricity quantity of the power consumer is greater than or equal to a sum of the declared electricity quantities of the power generation enterprises, making the transaction according to the declared electricity quantities of the power generation enterprises; and when the declared electricity quantity of the power consumer is less than the sum of the declared electricity quantities of the power generation enterprises, distributing, by the power generation enterprises, the declared electricity quantities to the power consumer according to a proportion of the declared electricity quantities; and
iii. if the price difference between a plurality of power consumers and a plurality of power generation enterprises is the same, when a sum of the declared electricity quantities of the power generation enterprises is greater than or equal to a sum of the declared electricity quantities of the power consumers, distributing, by the power generation enterprises, the declared electricity quantities to the power consumers according to a proportion of the declared electricity quantities; and when a sum of the declared electricity quantities of the power sales subjects is less than the sum of the declared electricity quantities of the power consumers, distributing, by the power consumers, the declared electricity quantities of the power generation enterprises according to a proportion of the declared electricity quantities;
\textcircled{3} under a certain group of tradable price differences, if the declared electricity quantities of the power generation enterprises and the declared electricity quantities of the power consumers are different, generating a remaining electricity quantity to be traded, wherein the remaining electricity quantity is capable of continuing to participate in the electricity quantity matching of other price difference groups; and
\textcircled{4} by analogy, obtaining a preliminary trading result corresponding to 24 hours a day.

8. The transaction method of the multi-subject flexible energy block bidding transaction system in the power market according to claim 5, wherein a calculation formula C of the social welfare in the Step 5 is as follows:
$$C = {\sum }_{j = 1}^{24} ( {\sum }_{i = 1}^{n} {q}_{bij}^{′} {p}_{bij} - {\sum }_{i = 1}^{m} {q}_{sij}^{′} {p}_{sij} )$$
wherein, q′ₛᵢⱼ and pₛᵢⱼ respectively represent a traded electricity quantity and a declared electricity price of an i^{th} power generation enterprise at a j^{th} time period respectively, while q′_{bij} and p_{bij} respectively represent a traded electricity quantity and a declared electricity price of an i^{th} power consumer at the j^{th} time period.

9. The transaction method of the multi-subject flexible energy block bidding transaction system in the power market according to claim 5, wherein the specific implementation method of the Step 6 comprises the following steps of:
(1) receiving a supply curve, a demand curve and a social welfare value corresponding to the ordinary hour mode as an initial supply curve, an initial demand curve and an initial social welfare value;
(2) according to a declaration time sequence, adding the supplied electricity quantity of the flexible hour mode to the initial supply curve according to a price order to form a new initial supply curve, and form new trading results one by one according to the trading matching method;
(3) calculating the all-day social welfare under the trading result, wherein if the social welfare increases, the declared electricity quantity is traded; if the social welfare decreases or remains unchanged, the declared electricity quantity is incapable of being traded; if the transaction is successful, updating the initial supply curve and the social welfare; and if the transaction is not traded, remaining the initial supply curve and the social welfare value unchanged;
(4) repeating the process until all the transaction demands that select the flexible hour declaration mode are all subjected to the matching procedure; and
(5) performing, by the data verifying module, safety verification on the preliminary trading results in the flexible hour mode, and obtaining a power transaction result in the flexible hour mode.

10. The transaction method of the multi-subject flexible energy block bidding transaction system in the power market according to claim 5, wherein the specific implementation method of the Step 7 comprises the following steps of:
(1) receiving a supply curve, a demand curve and a social welfare value corresponding to the flexible hour mode as an initial supply curve, an initial demand curve and an initial social welfare value;
(2) according to a declaration time sequence, adding the supplied electricity quantity of each hour selecting the block mode to a supplied electricity quantity sequence of a corresponding time period to form a new supply curve of the corresponding time period, and form new trading results one by one according to the above trading matching method;
(3) calculating the all-day social welfare under the trading result, wherein if the social welfare increases, the declared electricity quantities of the several time periods are traded at the same time; if the social welfare decreases or remains unchanged, the declared electricity quantities are incapable of being traded; if the transaction is successful, updating the initial supply curve and the social welfare; and if the transaction is not traded, remaining the initial supply curve unchanged;
(4) repeating the process until all the transaction demands that select the block declaration mode are all subjected to the matching procedure; and
(5) performing, by the data verifying module, safety verification on the preliminary trading results in the block mode, and finally obtaining a power transaction result in the block mode.
